(19) United States
(12) Patent Application Publication
(10) Pub. No.: US 2016/0186303 A1
(43) Pub. Date: Jun. 30, 2016

(54) CPC Laminated Composite Material And Method Of Producing The Same

(71) Applicants: Tian-Long Tungsten & Molybdenum (Tianjin) Co., Ltd., Tianjin (CN); Beijing Tian-Long Tungsten & Molybdenum Co., Ltd., Beijing (CN); Baoji Jing-Long Tungsten & Molybdenum Co., Ltd., Baoji (CN)

(72) Inventors: Yibing Yang, Beijing (CN); Guojun Su, Beijing (CN); Ming Zhong, Beijing (CN); Xueguang Luo, Beijing (CN); Junhai Liu, Beijing (CN); Ruirui Han, Beijing (CN)

(21) Appl. No.: 14/982,004

(22) Filed: Dec. 29, 2015

(30) Foreign Application Priority Data
Dec. 30, 2014 (CN) 201410837722.2

(51) Int. Cl. C22F 1/08; C21D 1/26; C21D 9/46; C22C 27/04; B32B 15/01; B22F 1/00; B22F 3/00; B22F 3/16; B22F 9/04; C22F 1/18; C22C 1/04

(52) U.S. Cl. CPC C22F 1/08; C22F 1/18; C21D 1/26; C21D 9/46; C22C 27/04; C22C 1/045; B22F 1/0003; B22F 3/003; B22F 3/16; B22F 9/04; B32B 15/01; B22F 2003/248

(57) ABSTRACT

The present invention relates to a method of producing a Mo—Cu alloy, comprising the following steps: (1) providing dispersed molybdenum powder, (2) producing a molybdenum skeleton with said dispersed molybdenum powder in step (1), (3) infiltrating said molybdenum skeleton in step (2) with copper and said Mo—Cu alloy is obtained; wherein said dispersed molybdenum powder has (D90−D0)/D50 of less than or equal to 2.1. The present invention also relates to a Mo—Cu alloy, a Mo—Cu alloy sheet, a method of producing a CPC laminated composite material and a CPC laminated composite material.

### TECHNICAL FIELD

The present invention relates to a composite material, and in particular to a composite material useful as heat sinks for microelectronic packaging. More specifically, the present invention relates to a CPC laminated composite material, and a method of producing the same.

### BACKGROUND

With the rapid development of integrated circuit (IC) industry, the integration scale and density of ICs are increasing and the width of the wiring has decreased from micron level to submicron level. This will reduce the connection reliability of the chip and the substrate, and will increase heat dissipation of per unit area of the chip. As a result, the devices are apt to fail in high temperature environment. To fundamentally solve the problems above, the packaging technique must be further improved, and besides, it is necessary to find new packaging materials.

Traditional electronic packaging materials such as Invar, Kovar, W, Mo, etc are unable to meet the ever-growing needs of microelectronic packaging industry, due to the simpleness of their properties. Novel microelectronic packaging materials with low expansion, low density, high thermal conductivity, suitable strength and low production costs are what the current research aims at. Generally, the above demanding requirements on properties can be hardly achieved through the single material. Composite materials such as Mo—Cu, W—Cu and Cu—Mo—Cu, which can take full advantage of each single material and exhibit better comprehensive properties, are becoming the electric packaging material for the next generation.

In this condition, as the third generation microelectronic package material, copper/molybdenum-copper/copper planer laminated composite material (CPC laminated composite material for short) is able to fulfill the needs of advanced electronic equipment due to its superior overall performance. The CPC laminated composite material is a composite material comprising a molybdenum-copper alloy (Mo—Cu alloy for short) layer coated with two copper layers on each side. The Mo—Cu alloy, as the core layer of the CPC laminated composite material, comprises molybdenum (Mo) and copper (Cu), wherein Mo has a body-centered cubic structure and Cu has a face-centered cubic structure. Mo and Cu can neither solid solute with each other, nor can form intermetallic compounds with each other. They can only form a mixed structure. Therefore, the Mo—Cu alloy is generally referred to as Mo—Cu pseudoalloy. Cu phase has a network-like distribution in the Mo—Cu alloy layer and Cu has good electrical and thermal conductivity. As a result, the Mo—Cu alloy layer and even the entire CPC composites material have enhanced electrical and thermal conductivity in both planar direction and thickness direction. Furthermore, due to the high strength, high hardness and low coefficient of expansion of molybdenum as the core material of Mo—Cu alloy, the CPC laminated composite materials also have good mechanical properties and excelling comprehensive properties.

At present, the research of CPC laminated composite material has only been progressed for less than a decade and the study thereon is still not mature either in China or in abroad. Till now, only several companies in the US and Japan have succeed in developing this material, while the technical information of this material is strictly confidential. No reports on this material have been published. Therefore, researching, developing and manufacturing of CPC laminated composite materials can not only fill the gaps of this field in China, but also can fulfill the needs of IC packing industry as well as can bring enormous economic benefits.

One conventional method for producing the CPC laminated composite material is to laminate a Cu sheet, a Mo—Cu alloy sheet and a Cu sheet together and to roll the laminated layers then. However, because Mo and Cu differ greatly in properties, it is quite difficult to choose proper roll-bonding parameters. As a result, defects like cracking edges, uneven thickness of layers, curved boundaries, and thickness ratio between each layer being too big or too small, occur frequently during the manufacturing process. Therefore, CPC laminated composite materials can hardly be obtained with high quality.

### SUMMARY OF THE INVENTION

Given the problems existing in the prior art, it is an object of the present invention to provide a CPC laminated composite material. It is another object of the present invention to provide a method of producing a CPC laminated composite material. It is a further object of this invention to provide a molybdenum-copper alloy (hereinafter referred to as a Mo—Cu alloy). It is still a further object of this invention to provide a method of producing a Mo—Cu alloy.

The present inventors found that a Mo—Cu alloy having excellent rollability can be obtained by using a molybdenum powder with uniform particle size distribution, and performing steps of compacting and copper infiltrating. Besides, a CPC laminated composite materials with uniform layer thickness can be obtained by laminating a sheet made of said Mo—Cu alloy and two copper sheets and subjecting the same to rolling.

In an embodiment of the present invention, it provided a method of producing a Mo—Cu alloy, comprising:

(1) providing a dispersed molybdenum powder,

(2) producing a molybdenum skeleton with said dispersed molybdenum powder obtained in step (1),

(3) infiltrating said molybdenum skeleton obtained in step (2) with copper, and said Mo—Cu alloy is obtained;

wherein, said dispersed molybdenum powder has (D90−D0)/D50 of less than or equal to 2.1, preferably less than or equal to 2.0, more preferably less than or equal to 1.9, less than or equal to 1.8, less than or equal to 1.7, or less than or equal to 1.6.

In another embodiment of the present invention, it provided a Mo—Cu alloy, which is produced by the method in the abovementioned embodiments of the present invention.

In another embodiment of the present invention, it provided a Mo—Cu alloy sheet, which is produced by processing said Mo—Cu alloy in the abovementioned embodiments of the present invention.

In another embodiment of the present invention, it provided a method of producing a CPC laminated composite material comprising:

(1) forming a multilayer sheet by laminating a copper sheet, a Mo—Cu alloy sheet and a copper sheet together in sequence;

(2) rolling said multilayer sheet,

said Mo—Cu alloy sheet is the Mo—Cu alloy sheet in the abovementioned embodiments of the present invention,

preferably, at least one of the copper sheets is an oxygen-free copper sheet.

In another embodiment of the present invention, it provided a CPC laminated composite material, which is produced by the method in the abovementioned embodiments of the present invention.

In another embodiment of the present invention, it provided a CPC laminated composite material, which comprises a Mo—Cu alloy layer and two copper layers with said Mo—Cu alloy layer being sandwiched between the two copper layers, wherein the thickness deviation (TD) of said Mo—Cu alloy layer is less than or equal to 10%, further less than or equal to 7%, still further less than or equal to 5%, yet further less than or equal to 3%, further less than or equal to 1%. The CPC laminated composite material could be produced by the method in the abovementioned embodiments of the present invention.

Raw molybdenum powder usually contains large agglomerates, which is generally referred to as secondary particles. The present invention crushed the aforementioned secondary particles to obtain a more dispersed powder, which is generally referred to as primary particles; and then by removing the coarse powder and the fine powder from the molybdenum powder, a dispersed molybdenum powder with a narrow particle size distribution is obtained. It should be noted that those skilled in the art well understand the concept of primary particles and secondary particles. The above content is not the definition of primary particles or secondary particles, but merely a further explanation of the embodiments of the present invention.

With respect to D0, D25, D50, D75 and D90 in the present invention, said “Dn” (for example, n=0, 25, 50, 75 or 90) denotes the particle size of n % (by weight) in the cumulative particle size distribution measured by laser diffraction method (i.e., the particle size till the point of n wt % cumulated starting from small particle size). For Example, D90 denotes the particle size of 90 wt % in the cumulative particle size distribution (by weight) from the small particle size. Since all the particles of the molybdenum powder of the present invention have the same density, the volume-based cumulative particle size distribution (D0, D25, D50, D75, D90) is substantially as same as the weight-based cumulative particle size distribution (D0, D25, D50, D75, D90). In this invention, unless otherwise indicated, the cumulative particle size distribution is on mass basis.

In the present invention, the term “coarse molybdenum powder” denotes the molybdenum powder component having a relatively large particle size, while the term “fine molybdenum powder” denotes the molybdenum powder component having a relative small particle size. For example, to remove the coarse molybdenum powder accounted for 10% of the total weight of molybdenum powder means to remove the powder component having a particle size larger than or equal to D90; while to remove the fine molybdenum powder component accounted for 10% of the total weight of the molybdenum powder means to remove the powder component having a particle size smaller than or equal to D10, and so forth.

In the present invention, the term “MoαCuβ alloy” denotes a Mo—Cu alloy having a mass ratio Mo/Cu of α:β (α+β=100). For example, Mo70Cu30 denotes a Mo—Cu alloy having a mass ratio Mo/Cu of 70:30, and so forth.

In the present invention, the term “relative density” denotes the ratio of measured density to theoretical density.

In the present invention, the CPC laminated composite material comprises two copper layers and a Mo—Cu alloy layer with said Mo—Cu alloy layer being sandwiched between the two copper layers. In order to illustrate the uniformity of the CPC laminated composite material of the present invention, the present invention provides a method for measuring thereof

Specifically, as shown in FIG. 1, a cross section photograph of a CPC laminated composite material is taken with a scanning electron microscope. Along the direction parallel to the Mo—Cu boundary within a length of about 3 mm, the thicknesses of each copper layer (or Mo—Cu alloy layer) were measured respectively. Measuring points were chosen in such a way that: for each layer, along the direction parallel to the boundary within a length of 3 mm, a measuring point was taken every 0.4˜0.6 mm and five measuring points were taken in total, with five measured thickness values (FMTVs for short hereinafter) of the layer obtained.

Furthermore, in order to quantify the thickness uniformity of each layer and the thickness homogeneity of multiple layers, the present invention makes following definitions:

Mean thickness (MT for short hereinafter) of a single layer: the mean value of FMTVs of the layer.

Thickness deviation (TD for short hereinafter) of a single layer: the ratio of the range of the layer's FMTVs to the single layer's MT.

Mean thickness (MT) of multiple layers: the mean value of each single layer's MT.

Thickness deviation (TD) of multiple layers: the ratio of the range of each single layer's MT to the MT of the multiple layers.

The smaller the TD of a layer, the more uniform the thickness of the layer, the smaller the TD of multiple layers, the more homogenous the thicknesses of the multiple layers.

Compared with the prior art, the CPC laminated composite material of the present invention has at least one of the following advantages:

(1) The TD of the Mo—Cu alloy single layer is smaller;

(2) the TD of the copper layer is smaller;

(3) the TD of the two copper layers is smaller.

### BRIEF DESCRIPTION OF THE DRAWING

The drawings described herein provided a further explanation of the present invention. They constitute a part of this application. The illustrative Examples and descriptions thereof are to explain the present invention, rather than to form undue restriction to the present invention.

FIG. 1 is a scanning electron micrograph of the raw molybdenum powder in Example 1.

FIG. 2 is a scanning electron micrograph of the dispersed molybdenum powder in Example 1.

FIG. 3 is a scanning electron micrograph of a cross section of the CPC laminated composite material in Example 1.

FIG. 4 is a scanning electron micrograph of a cross section of the CPC laminated composite material in Example 2.

FIG. 5 is a scanning electron micrograph of a cross section of the CPC laminated composite material in Example 3.

FIG. 6 is an optical microscope magnified photograph (30× magnification) of a cross section of the CPC laminated composite material in Comparative Example 1.

FIG. 7 is a photo of a cross section of the CPC laminated composite material in Comparative Example 2.

FIG. 8 is an optical microscope magnified photograph (10× magnification) of a side view of the CPC laminated composite material in Example 1 after being etched.

FIG. 9 is a photo of a stamped CPC laminated composite material made of the CPC laminated composite material in Example 1.

### DESCRIPTION OF THE PREFERRED EMBODIMENTS

The present invention provides the following specific embodiments and all the possible combinations thereof. For brevity, this application does not explicitly list every specific combination of embodiments, but it should be considered that all the possible combinations of every specific embodiment is specifically recorded and disclosed in the present application.

In an embodiment of the present invention, it provided a method of producing a Mo—Cu alloy, comprising the following steps:

(1) providing dispersed molybdenum powder,

(2) producing a molybdenum skeleton with said dispersed molybdenum powder in step (1),

(3) infiltrating said molybdenum skeleton in step (2) with copper and said Mo—Cu alloy is obtained;

wherein, said dispersed molybdenum powder has (D90−D0)/D50 of less than or equal to 2.1, preferably less than or equal to 2.0, still more preferably less than or equal to 1.9, less than or equal to 1.8, less than or equal to 1.7 or less than or equal to 1.6.

In a preferred embodiment of the present invention, it provided a method of producing a Mo—Cu alloy, wherein said dispersed molybdenum powder has D90−D0 of less than or equal to 20 μm, preferably less than or equal to 15 μm, still more preferably less than or equal to 10 μm, 9 μm or 8 μm.

In a preferred embodiment of the present invention, it provided a method of producing a Mo—Cu alloy, wherein, said dispersed molybdenum powder has D50 of 1˜20 μm, e.g. 1˜15 μm, 1˜10 μm, 3˜7 μm or 4˜5 μm.

In a preferred embodiment of the present invention, it provided a method of producing a Mo—Cu alloy, wherein step (1) comprises the following steps:

adjusting the particle size of the raw molybdenum powder,

said step of adjusting the particle size of the raw molybdenum powder denotes the following: crushing the agglomerates in the molybdenum powder to obtain primary particles, and then removing a coarse powder accounted for more than or equal to 1%, preferably 1-10% (e.g., 1%, 3%, 5%, 7% or 10%) of the total mass of the molybdenum powder and/or removing a fine powder accounted for more than or equal to 1%, preferably 1-10% (for Example, 1%, 3%, 5%, 7% or 10%) of the total mass of molybdenum powder by classifying.

In a preferred embodiment of the present invention, it provided a method of producing a Mo—Cu alloy, wherein said step of adjusting the particle size of the raw molybdenum powder is carried out with a particle size classifying equipment; preferably, said particle size classifying equipment is an air crushing and classifying device.

In a preferred embodiment of the present invention, it provided a method of producing a Mo—Cu alloy, wherein said raw molybdenum powder has D50 of 1˜20 μm e.g. 1˜15 μm, 1˜10 μm, 3˜7 μm, 4˜5 μm or 5˜6 μm.

In a preferred embodiment of the present invention, it provided a method of producing a Mo—Cu alloy, wherein step (2) comprises the following steps:

compacting a dispersed molybdenum powder or a powder blend consisting of dispersed molybdenum powder and copper powder into a green compact;

and optionally, sintering said green compact;

preferably, said powder blend consisting of dispersed molybdenum powder and copper powder has a copper powder mass content of 5%-20%.

In a preferred embodiment of the invention, it provided a method of producing a Mo—Cu alloy, wherein said infiltrating in step (3) is carried out at a temperature of 1250˜1450° C., preferably at 1300˜1400° C., still more preferably at 1325˜1375° C.

In a preferred embodiment of the invention, it provided a method of producing a Mo—Cu alloy, wherein the infiltrating in step (3) proceeds for 1˜5 hours, preferably for 2˜4 hours, still more preferably for 2.5˜3.5 hours.

In a preferred embodiment of the invention, it provided a method of producing a Mo—Cu alloy, wherein the infiltrating in step (3) is carried out in a copper infiltrating furnace.

In an embodiment of the present invention, it provided a Mo—Cu alloy, which is produced by any one of the methods in the abovementioned embodiments of the present invention.

In a preferred embodiment of the invention, it provided a Mo—Cu alloy, the Mo—Cu alloy having a molybdenum content of at least 40% by weight, for example 40˜90% by weight, 50˜80% by weight, or 60˜70% by weight.

In a preferred embodiment of the invention, it provided a Mo—Cu alloy, the Mo—Cu alloy having a relative density of more than or equal to 95%, preferably more than or equal to 97%, still more preferably more than or equal to 99%.

In an embodiment of the present invention, it provided a Mo—Cu alloy sheet, which is obtained by processing the Mo—Cu alloy in the abovementioned embodiments of the present invention.

In a preferred embodiment of the present invention, it provided a Mo—Cu alloy sheet having a surface roughness Ra of less than or equal to 1.4 μm, preferably less than or equal to 1.2 μm, preferably less than or equal to 1 μm, still more preferably less than or equal to 0.8 μm.

In a preferred embodiment of the present invention, it provided a Mo—Cu alloy sheet having a thickness tolerance of within ±0.3 mm, preferably within ±0.1 mm.

In a preferred embodiment of the present invention, it provided a Mo—Cu alloy sheet, wherein said processing is diamond wire cutting.

In a preferred embodiment of the present invention, it provided a Mo—Cu alloy sheet, wherein said processing is wire cutting and polishing.

In a preferred embodiment of the present invention, it provided a Mo—Cu alloy sheet having a thickness of 5˜15 mm.

In an embodiment of the present invention, it provided a method of producing a CPC laminated composite material, compromising the following steps:

(1) forming a multilayer sheet by laminating a copper sheet, a Mo—Cu alloy sheet and a copper sheet together in sequence;

(2) rolling the multilayer sheet,

said Mo—Cu alloy sheet is the Mo—Cu alloy sheet in the aforementioned embodiments of the present invention,

preferably, at least one of said copper sheet is an oxygen-free copper sheet.

In a preferred embodiment of the present invention, it provided a method of producing a CPC laminated composite material, further comprising a step between steps (1) and (2) of mechanically fixing each layer of the multilayer sheet, preferably the fixing is performed by riveting.

In a preferred embodiment of the present invention, it provided a method of producing a CPC laminated composite material, wherein said rolling in step (2) includes one or more steps of cold rolling and/or hot rolling, optionally, and further includes steps of annealing.

In a preferred embodiment of the present invention, it provided a method of producing a CPC laminated composite material, wherein said hot rolling step includes the following operations: heating the multilayer sheet to a temperature of 600-1000° C. (e.g., 700˜900° C. or 800˜850° C.), preferably soaking the multilayer sheet for 0.5˜2.5 hours (e.g. 1˜2 hours), and then hot rolling the multilayer sheet with a hot rolling machinery.

In a preferred embodiment of the present invention, it provided a method of producing a CPC laminated composite material, wherein said hot rolling is carried out at a reduction rate of 30˜70%, e.g., 40˜70% or 50˜66%.

In a preferred embodiment of the present invention, it provided a method of producing a CPC laminated composite material, wherein said annealing is carried out at a temperature of 600˜1000° C., e.g. 800˜1000° C.

In a preferred embodiment of the present invention, it provided a method of producing a CPC laminated composite material, wherein the cold rolling is carried out at a reduction of 0.01-0.5 mm per pass, e.g. 0.05˜0.3 mm per pass or 0.1˜0.2 mm per pass.

In a preferred embodiment of the present invention, it provided a method of producing a CPC laminated composite material, further comprising a step of stamping after step (2).

In a preferred embodiment of the present invention, it provided a method of producing a CPC laminated composite material, wherein said stamping is carried out at a stamping pressure of 16 tons, and preferably, said stamping is carried out for multiple times, e.g. for 3-5 times.

In an embodiment of the present invention, it provided a CPC laminated composite material, which is produced by the method in the aforementioned embodiment of the present invention methods.

In an embodiment of the present invention, it provided a CPC laminated composite material compromising one Mo—Cu alloy layer and two copper layers, with said Mo—Cu alloy layer being sandwiched between the two copper layers, wherein the thickness deviation (TD) of said Mo—Cu alloy layer is less than or equal to 10%, further less than or equal to 7%, further less than or equal to 5%, further less than or equal to 3%, and still further less than or equal to 1%.

In a preferred embodiment of the present invention, it provided a CPC laminated composite material, wherein the thickness deviation of said copper layer is less than or equal to 10%, further less than or equal to 6%, still further less than or equal to 3%.

In a preferred embodiment of the present invention, it provided a CPC laminated composite material wherein the thickness deviation (TD) of the two copper layers is less than or equal to 10%, further less than or equal to 6%, further less than or equal to 4%, further less than or equal to 2%, and still further less than or equal to 1%.

In a preferred embodiment of the present invention, it provided a CPC laminated composite material, wherein the material has a thickness of 100˜5000 μm,

preferably, the thickness of the Mo—Cu alloy layer is 100˜1000 μm,

preferably, the thickness of the copper layer is 100˜1000 μm,

preferably, the thickness ratio that copper layer:Mo—Cu alloy layer:copper layer is 1:1:1˜1:4:1.

The following figures and Examples further describe the embodiments of the present invention in detail.

As used in this application, and the skilled person is well known, when the particle size of the powder represented by mesh number, the sign “+” or “−” before the mesh number indicates “not pass” or “pass” the sieve. For Example, “−80 mesh” indicates can pass a 80 mesh sieve, and “+100 mesh” means cannot pass a 100 mesh sieve.

The equipments and corresponding models used in the present invention are listed in TABLE 1.

TABLE 1
Equipments and Models

| Equipments | Models |
|---|---|
| air crushing and classifying device | MQW10 |
| cold isostatic pressing equipment | LDJ-4000-1 |
| sintering furnace | SJL-1100 |
| copper infiltrating furnace | According to CN101838765A |
| multiwire diamond cutting machine | CHSXD20-1 |
| laser thermal conductivity meter | LFA447NanoFlash |
| optical microscope | ST60 |
| JEOL scanning electron microscope | JSM-6510A |
| density measuring device | JA2003 |
| laser particle size analyzer | OMEC LS-POP(VI) |

### Example 1

### A CPC Laminated Composite Material Having a Thickness Ratio that Copper Layer:Mo—Cu Alloy Layer:Copper Layer of 1:4:1

Step A. A raw molybdenum powder was processed with an air crushing and classifying device to crush the agglomerates therein, and then the coarse powder (having a relatively large particle size) accounted for 10% of the total weight of the raw molybdenum powder and the fine powder (having a relatively small particle size) accounted for 1% of the total weight of the raw molybdenum powder were removed by classifying. A dispersed molybdenum powder with narrow particle size distribution was obtained. The particle sizes of the raw molybdenum powder and the dispersed molybdenum powder are shown in TABLE 2.

Step B. The dispersed molybdenum powder obtained in step A was mixed with a −300 mesh copper powder, which accounted for 5% of the total weight of the mixed powder. The mixed powder was blended in a V-type blending tank for 8 hours, and then was compacted by cold isostatic pressing at room temperature with an isostatic pressure of 220 MPa. A molybdenum skeleton measuring length 405 mm×width 305 mm×thickness 105 mm was obtained.

Step C. The molybdenum skeleton obtained in step B was infiltrated with copper in a copper infiltrating furnace to produce a crude blank. The infiltrating was performed at a temperature of 1350° C. for 4 hours. Residual copper was removed from the surface of the crude blank by milling and grinding. A Mo70Cu30 alloy measuring length 400 mm×width 300 mm×thickness 100 mm was obtained, and it has a measured density of 9.70 g/cm³ and a relative density of 99.18%.

Step D. The Mo—Cu alloy obtained in Step C was wire cut into Mo—Cu alloy sheets measuring length 300 mm×width 400 mm×thickness 12 mm with a multiwire diamond cutting machine, the Mo—Cu alloy sheet having a thickness tolerance of ±0.1 mm as well as a roughness Ra of 0.8 μm.

Step E. To remove oil and dust from the Mo—Cu alloy sheet obtained in Step D, the sheet were surface processed by being washed with a NaOH solution, then with a mixed solution of hydrochloric acid and sulfuric acid and finally with deionized water.

Step F. Two oxygen-free copper sheets are riveted on the surface processed Mo—Cu alloy sheet obtained in step E on both sides thereof, the oxygen-free copper sheets measuring length 430 mm×width 330 mm×thickness 3.8 mm. The riveted sheet was heated to 850° C. and soaked for 2 hours under H₂ protective atmosphere. The heated sheet was hot rolled with an Ø500×500 mm hot rolling machine at a reduction rate of 66%. A composite sheet having a thickness of 6.66 mm was thus obtained. Trimming off the cracked edges of the composite sheet, and a hot-rolled composite sheet measuring length 820 mm×width 380 mm×thickness 6.66 mm was obtained. The production yield was 88.23%, which was quite high.

Step G. The hot rolled composite sheet obtained in step F was annealed at 1000° C. for 1 hour under H₂ protective atmosphere, then was drawn from high temperature zone to cooling zone for cooling. No bubbles, delaminations or cracks occurred.

Step H. The annealed composite sheet obtained in step G was cold rolled with a four-roll cold rolling machine (having working roll sizes of Ø200×700 mm) at a reduction amount of 0.01-0.5 mm per pass. Finally, a CPC laminated composite material having a thickness of 1.01 mm was finally obtained.

The thermal conductivity of the CPC laminated composite material was 340 W/MK in flat direction and 300 W/MK in thickness direction.

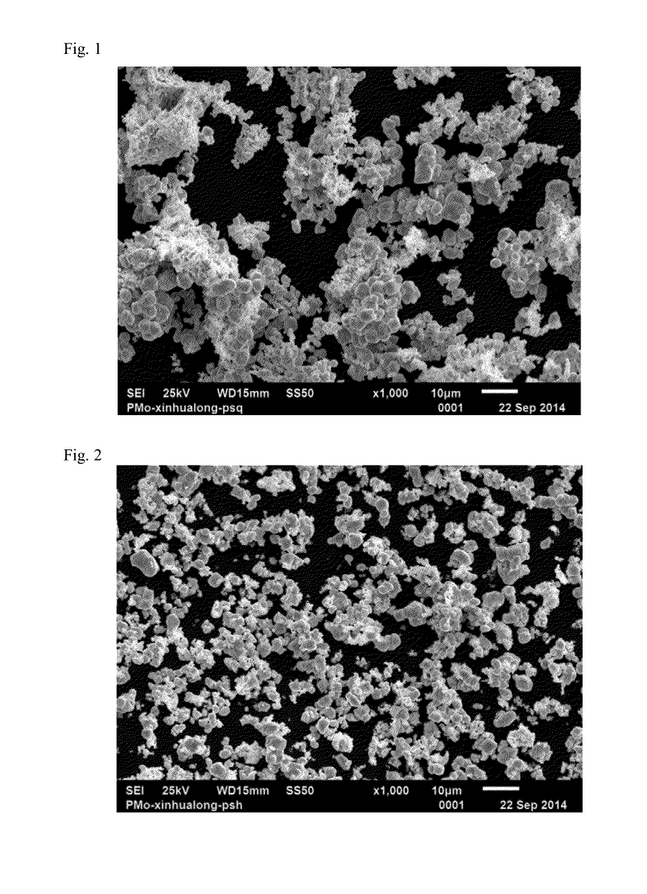

FIG. 1 is a scanning electron micrograph of the raw molybdenum powder in Example 1, which was not processed by air crushing and classifying device. The raw molybdenum powder has an uneven particle size distribution and contains many large agglomerates, whose sizes are generally larger than 10 μm.

FIG. 2 is a scanning electron micrograph of the dispersed molybdenum powder in Example 1. The dispersed molybdenum powder has been processed by air crushing and classifying device. The dispersed molybdenum powder has an uniform particle size distribution, substantially without large agglomerates therein, and having an average particle size of 5 μm.

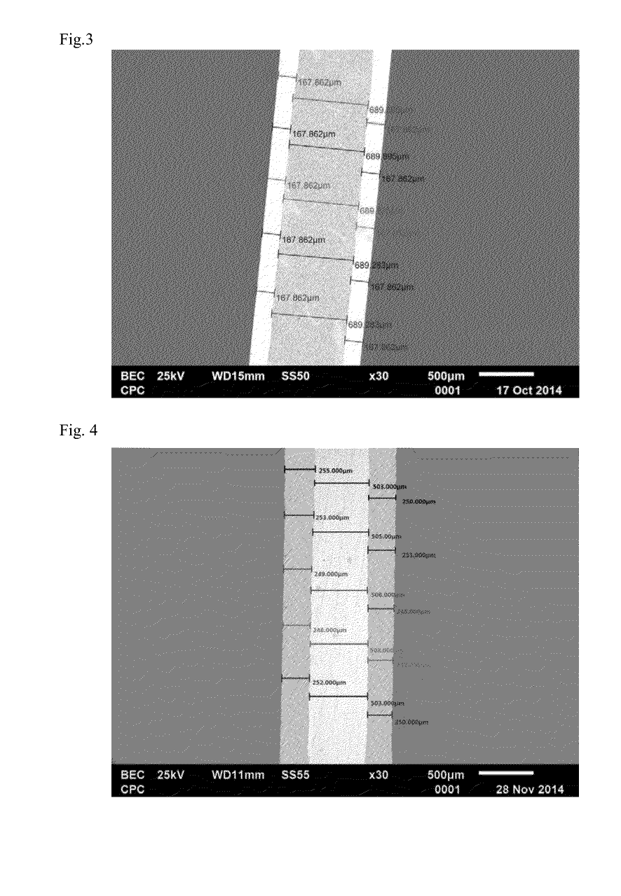

FIG. 3 is a scanning electron micrograph of a cross section of the CPC laminated composite material in Example 1. From left to right, the three layers are the first copper layer, the Mo—Cu alloy layer and the second copper layer, whose thicknesses are approximately 0.17 mm, 0.67 mm and 0.17 mm, respectively. The thickness ratio of them is in line with the predetermined 1:4:1.

FIG. 8 is an optical microscope photograph (10× magnification) of the side view of a CPC laminated composite material in Example 1 with etched side. It can be seen that the thicknesses of and the Mo—Cu alloy layer and the two copper layers are very constant, which remain almost unchanged along the longitudinal direction of the boundary. Besides, the copper layers on both sides have equal thickness, rather than one being too thick while the other being too thin. The bonding interfaces between the Mo—Cu alloy layer and the copper layer are well-bonded with no defects such as gaps, cracks or etc.

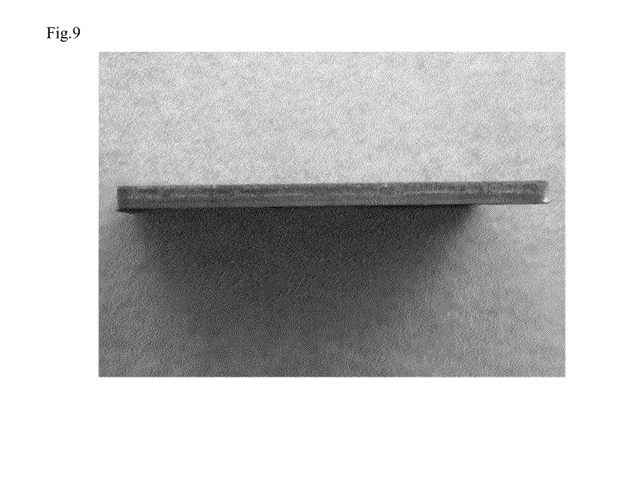

FIG. 9 is a photo of a stamped CPC laminated composite material made of the CPC laminated composite material in Example 1. The stamping was performed for 3-5 times with a stamping force of 16 tons. Because copper is very soft, the copper layers may adhere on the Mo—Cu alloy layer when being stamped. Therefore, no clear boundaries delineating the thickness could be found from the side view of the stamped CPC laminated composite material. As can be seen from the side view photo, the three layers are tightly bonded without delaminations or cracks. Therefore, the CPC laminated composite material of the present invention has good punchability.

### Example 2

### A CPC Laminated Composite Material Having a Thickness Ratio that Copper Layer:Mo—Cu Alloy Layer:Copper Layer of 1:2:1

Step A. A raw molybdenum powder was processed with an air crushing and classifying device to crush the agglomerates therein, and then the coarse powder (having a relatively large particle size) accounted for 7% of the total weight of the raw molybdenum powder and the fine powder (having a relatively small particle size) accounted for 7% of the total weight of the raw molybdenum powder were removed by classifying. A dispersed molybdenum powder with narrow particle size distribution was obtained. The particle sizes of the raw molybdenum powder and the dispersed molybdenum powder are shown in TABLE 2.

Step B. The dispersed molybdenum powder obtained in step A was mixed with a −300 mesh copper powder, which accounted for 20% of the total weight of the mixed powder. The mixed powder was blended in a V-type blending tank for 8 hours, and then was compacted by cold isostatic pressing at room temperature with an isostatic pressure of 220 MPa. A molybdenum skeleton measuring length 405 mm×width 305 mm×thickness 105 mm was obtained.

Step C. The molybdenum skeleton obtained in step B was infiltrated with copper in a copper infiltrating furnace to produce a crude blank. The infiltrating was performed at a temperature of 1300° C. for 5 hours. Residual copper was removed from the surface of the crude blank by milling and grinding. A Mo50Cu50 alloy measuring length 400 mm×width 300 mm×thickness 100 mm was obtained, and it has a measured density of 9.44 g/cm³ and a relative density of 99.31%.

Step D. The Mo—Cu alloy obtained in Step C was wire cut into Mo—Cu alloy sheets measuring length 300 mm×width 400 mm×thickness 10 mm with a multiwire diamond cutting machine, the Mo—Cu alloy sheet having a thickness tolerance of ±0.1 mm as well as a roughness Ra of 0.8 μm.

Step E. To remove oil and dust from the Mo—Cu alloy sheet obtained in Step D, the sheet were surface processed by being washed with a NaOH solution, then with a mixed solution of hydrochloric acid and sulfuric acid and finally with deionized water.

Step F. Two oxygen-free copper sheets are riveted on the surface processed Mo—Cu alloy sheet obtained in step E on both sides thereof, the oxygen-free copper sheets measuring length 430 mm×width 330 mm×thickness 6.2 mm. The riveted sheet was heated to 930° C. and soaked for 1.5 hours under H₂ protective atmosphere and then was hot rolled with an Ø500×500 mm hot rolling machine at a reduction rate of 70%. A composite sheet having a thickness of 6.72 mm was thus obtained. Trimming off the cracked edges of the composite sheet, and a hot-rolled composite sheet measuring length 820 mm×width 380 mm×thickness 6.72 mm was obtained. The production yield was 86%, which was quite high.

Step G. The hot rolled composite sheet obtained in step F was annealed at 1000° C. for 1 hour under H₂ protective atmosphere, then was drawn from high temperature zone to cooling zone for cooling. No bubbles, delaminations or cracks occurred on the sheet.

Step H. The annealed composite sheet obtained in step G was cold rolled with a four-roll cold rolling machine (having working roll sizes of 0200×700 mm) at a reduction amount of 0.01-0.5 mm per pass. Finally, a CPC laminated composite material having a thickness of 1.01 mm was finally obtained.

FIG. 4 is a scanning electron micrograph of a cross section of the CPC laminated composite material in Example 2. The thicknesses of the copper layer, the Mo—Cu alloy layer and the other copper layer are approximately 0.25 mm, 0.51 mm and 0.25 mm, respectively, which are substantially in line with the thickness ratio of 1:2:1.

### Example 3

### A CPC Laminated Composite Material Having a Thickness Ratio that Copper Layer:Mo—Cu Alloy Layer:Copper Layer of 1:1:1

Step A. A raw molybdenum powder was processed with an air crushing and classifying device to crush the agglomerates therein, and then the coarse powder (having a relatively large particle size) accounted for 7% of the total weight of the raw molybdenum powder and the fine powder (having a relatively small particle size) accounted for 5% of the total weight of the raw molybdenum powder were removed by classifying. Thus, a dispersed molybdenum powder with narrow particle size distribution was obtained. The particle sizes of the raw molybdenum powder and the dispersed molybdenum powder are shown in TABLE 2.

Step B. The dispersed molybdenum powder obtained in step A was mixed with a −300 mesh copper powder, which accounted for 5% of the total weight of the mixed powder. The mixed powder was blended in a V-type blending tank for 8 hours, and then was compacted by cold isostatic pressing at room temperature with an isostatic pressure of 220 MPa. A molybdenum skeleton measuring length 405 mm×width 305 mm×thickness 105 mm was obtained.

Step C. The molybdenum skeleton obtained in step B was infiltrated with copper in a copper infiltrating furnace to produce a crude blank. The infiltrating was performed at a temperature of 1350° C. for 4 hours. Residual copper was removed from the surface of the crude blank by milling and grinding. A Mo70Cu30 alloy measuring length 400 mm×width 300 mm×thickness 100 mm was obtained.

Step D. The Mo—Cu alloy obtained in Step C was wire cut into Mo—Cu alloy sheets with an ordinary multiwire cutting machine. The Mo—Cu alloy sheets were then ground with a grinding machine to a thickness of 8 mm and to a surface roughness Ra of 0.8 μm.

Step E. To remove oil and dust from the Mo—Cu alloy sheet obtained in Step D, the sheet were surface processed by being washed with a NaOH solution, then with a mixed solution of hydrochloric acid and sulfuric acid and finally with deionized water.

Step F. Two oxygen-free copper sheets are riveted on the surface processed Mo—Cu alloy sheet obtained in step E on both sides thereof, the oxygen-free copper sheets measuring length 430 mm×width 330 mm×thickness 10 mm. The riveted sheet was heated to 850° C. and soaked for 2 hours under H₂ protective atmosphere and then was hot rolled with an Ø500×500 mm hot rolling machine at a reduction rate of 70%. A composite sheet having a thickness of 8.4 mm was thus obtained. Trimming off the cracked edges of the composite sheet, and a hot-rolled composite sheet measuring length 820 mm×width 380 mm×thickness 8.4 mm was obtained. The production yield was 84.23%.

Step G. The hot rolled composite sheet obtained in step F was annealed at 1000° C. for 1 hour under H₂ protective atmosphere, then was drawn from high temperature zone to cooling zone for cooling. No bubbles, delaminations or cracks occurred on the sheet.

Step H. The annealed composite sheet obtained in step G was cold rolled with a four-roll cold rolling machine (having working roll sizes of Ø200×700 mm) at a reduction amount of 0.01-0.5 mm per pass. Finally, a CPC laminated composite material having a thickness of 1.49 mm was finally obtained.

FIG. 5 is a scanning electron micrograph of a cross section of the CPC laminated composite material in Example 3. The ratio of thicknesses of the copper layer, the Mo—Cu alloy layer and the other copper layer is substantially 1:1:1. The TD of the Mo—Cu alloy layer and the TD of the copper layer are both within 10%, besides, the TD of the two copper layers is within 10%, which meet the usage requirements.

### Comparative Example 1

Step A. A raw molybdenum powder same as the one in Example 1 was used, but the raw molybdenum, powder was not processed with air crushing and classifying device.

Step B. The raw molybdenum powder obtained in step A was mixed with a −300 mesh copper powder, which accounted for 5% of the total weight of the mixed powder. The mixed powder was blended in a V-type blending tank for 8 hours, and then was compacted by cold isostatic pressing at room temperature with an isostatic pressure of 220 MPa. A molybdenum skeleton measuring length 405 mm×width 305 mm×thickness 105 mm was obtained.

Step C. The molybdenum skeleton obtained in step B was infiltrated with copper in a copper infiltrating furnace to produce a crude blank. The infiltrating was performed at a temperature of 1350° C. for 4 hours. Residual copper was removed from the surface of the crude blank by milling and grinding. A Mo70Cu30 alloy measuring length 400 mm×width 300 mm×thickness 100 mm was obtained.

Step D. The Mo—Cu alloy obtained in Step C was wire cut into Mo—Cu alloy sheets measuring 400 mm×width 300 mm×thickness 12 mm with an diamond multiwire cutting machine, the Mo—Cu alloy sheet having a thickness tolerance of +0.1 mm and a roughness Ra of 0.8 μm.

Step E. To remove oil and dust from the Mo—Cu alloy sheet obtained in Step D, the sheet were surface processed by being washed with a NaOH solution, then with a mixed solution of hydrochloric acid and sulfuric acid and finally with deionized water.

Step F. Two oxygen-free copper sheets are riveted on the surface processed Mo—Cu alloy sheet obtained in step E on both sides thereof, the oxygen-free copper sheets measuring length 430 mm×width 330 mm×thickness 3.8 mm. The riveted sheet was heated to 850° C. and soaked for 2 hours under H₂ protective atmosphere and then was hot rolled with an Ø500×500 mm hot rolling machine at a reduction rate of 66%. A composite sheet having a thickness of 6.66 mm was thus obtained. Trimming off the cracked edges of the composite sheet, and a hot-rolled composite sheet measuring length 820 mm×width 380 mm×thickness 6.66 mm is obtained. The production yield was 83.27%.

Step G. The hot rolled composite sheet obtained in step F was annealed at 1000° C. for 1 hour under H₂ protective atmosphere, then was drawn from high temperature zone to cooling zone for cooling. No bubbles, delaminations or cracks occurred on the sheet.

Step H. The annealed composite sheet obtained in step G was cold rolled with a four-roll cold rolling machine (having working roll sizes of Ø×700 mm) at a reduction amount of 0.01-0.5 mm per pass. Finally, a CPC laminated composite material having a thickness of 1.01 mm was finally obtained.

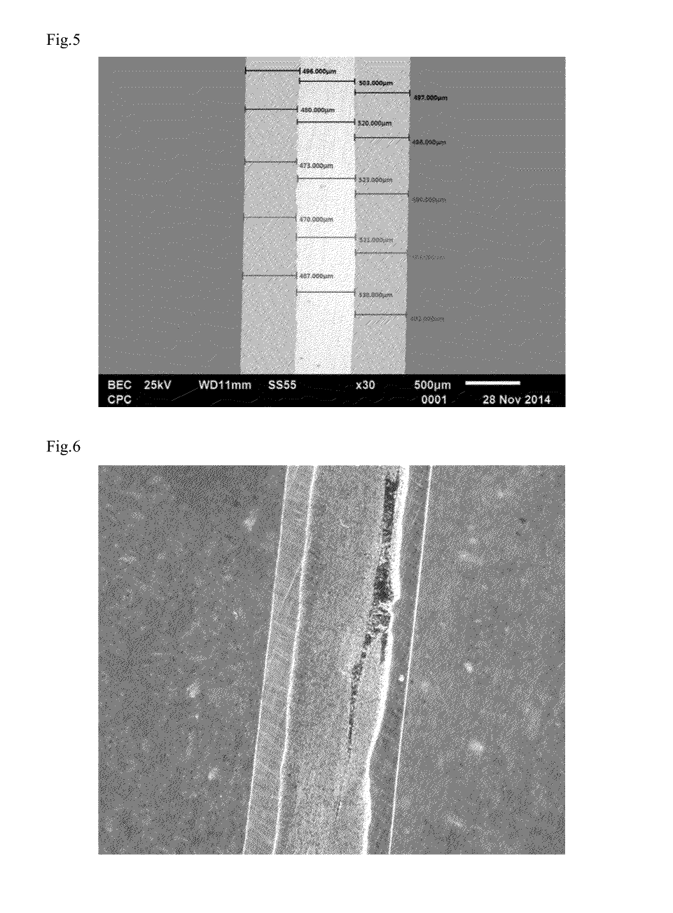

FIG. 6 is an optical microscope photograph the CPC laminated composite material in Comparative Example 1. There are apparent Mo-rich region (black in color) in the Mo—Cu alloy layer of the CPC laminated material. The Mo-rich region is harder than remaining regions, and thus uneven deformation occurred to the core material (the Mo—Cu alloy) during rolling process, which results in the uneven interfaces between the core material layer and the copper layers. The core material layer and the copper layers have inconstant thicknesses, which varies obviously along the longitudinal direction, as well as large thickness deviations (TD). In addition, two copper layers have different thicknesses, with the copper layer on the left obviously thicker than the one on the right.

### Comparative Example 2

Step A. A dispersed molybdenum powder, same as the one in Example 3, was used.

Step B. The dispersed molybdenum powder obtained in step A was mixed with a −300 mesh copper powder, which accounted for 5% of the total weight of the mixed powder. The mixed powder was blended in a V-type blending tank for 8 hours, and then was compacted by cold isostatic pressing at room temperature with an isostatic pressure of 220 MPa. A molybdenum skeleton measuring length 405 mm×width 305 mm×thickness 105 mm was obtained.

Step C. The molybdenum skeleton obtained in step B was infiltrated with copper in a copper infiltrating furnace to produce a crude blank. The infiltrating was performed at a temperature of 1350° C. for 4 hours. Residual copper was removed from the surface of the crude blank by milling and grinding. A Mo70Cu30 alloy measuring length 400 mm×width 300 mm×thickness 100 mm was obtained.

Step D. The Mo—Cu alloy obtained in Step C was wire cut into Mo—Cu alloy sheets measuring length 400 mm×width 300 mm×thickness 8 mm with a slow wire-cutting machine. The Mo—Cu alloy sheet had a thickness tolerance of ±0.1 mm and a roughness Ra of 1.6 μm.

Step E. To remove oil and dust from the Mo—Cu alloy sheet obtained in Step D, the sheet were surface processed by being washed with a NaOH solution, then with a mixed solution of hydrochloric acid and sulfuric acid and finally with deionized water.

Step F. Two oxygen-free copper sheets are riveted on the surface processed Mo—Cu alloy sheet obtained in step E on both sides thereof, the oxygen-free copper sheets measuring length 430 mm×width 330 mm×thickness 10 mm. The riveted sheet was heated to 850° C. and soaked for 2 hours under H₂ protective atmosphere and then was hot rolled with an Ø500×500 mm hot rolling machine. A composite sheet having a thickness of 8.4 mm was thus obtained. Trimming off the cracked edges of the composite sheet, and a hot-rolled composite sheet measuring length 820 mm×width 380 mm×thickness 8.4 mm is obtained.

Step G. The hot rolled composite sheet obtained in step F was annealed at 1000° C. for 1 hour under H₂ protective atmosphere, then was drawn from high temperature zone to cooling zone for cooling. Bubbles, delaminations and cracks occurred on certain part of the sheet.

Step H. The annealed composite sheet obtained in step G was cold rolled with a four-roll cold rolling machine (having working roll sizes of Ø200×700 mm) at a reduction amount of 0.01-0.5 mm per pass. Finally, a CPC laminated composite material having a thickness of 1.55 mm was finally obtained.

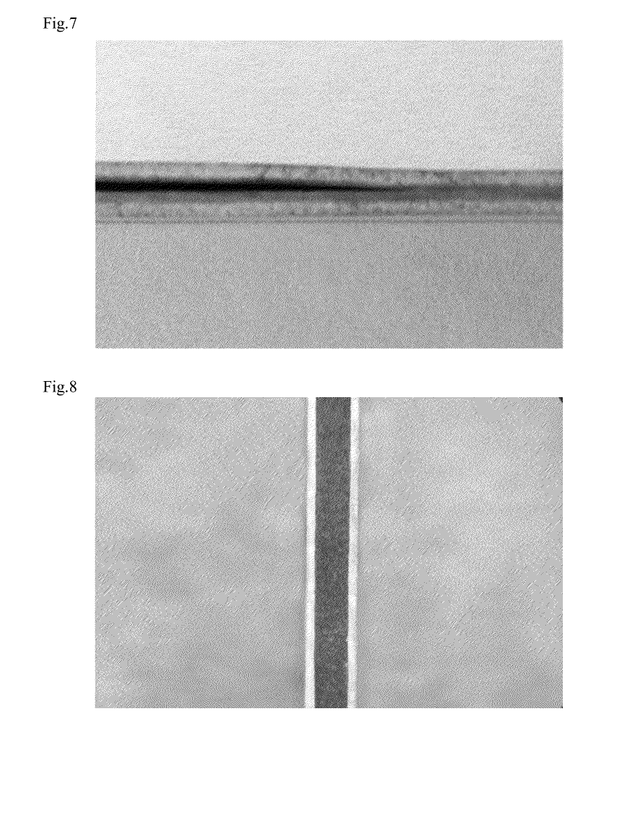

FIG. 7 is a photo of a cross section of the CPC laminated composite material in Comparative Example 2. The bonding interfaces of copper layers and the core material layer are not well bonded, with cracks appearing in some locations thereof.

TABLE 2 shows the particle size distribution data of the raw molybdenum powder and the dispersed molybdenum powder used in Examples and Comparative Examples of the present invention. As shown in TABLE 2, by removing a coarse molybdenum powder accounted for more than or equal to 1% of the total weight of the raw molybdenum powder and/or a fine molybdenum powder accounted for more than or equal to 1% of the total weight of the raw molybdenum powder, the present invention obtains a dispersed molybdenum powder with more uniform particle size distribution. The dispersed molybdenum powder was further used to produce the Mo—Cu alloy of the present invention. The Mo—Cu alloy was further used to produce the CPC laminated composite material of the present invention.

By using the methods for measuring the uniformity and/or homogeneity of the CPC laminated composite material in present invention, the thicknesses of the first copper layer, the Mo—Cu alloy layer, and the second copper layer of the CPC laminated composite materials in Examples 1˜3 were measured respectively. The corresponding thickness deviations (TD) of each layer and the thickness deviations (TD) of multiple layers were calculated. (See TABLE 3).

As shown in TABLE 3, the layer thicknesses of the CPC laminated composite material in Examples 1˜3 are very constant, both the single layer and the multiple layers have TD of within 10%. The Mo—Cu alloy layer has constant thickness and the boundaries of the Mo—Cu alloy layer the copper layers are straight, without curved patterns; the first copper layer and the second copper layer have equal thicknesses, rather than one being too thick while the other being too thin. Every layer is tightly bonded with each other, having no defects like voids, cracks or etc. The internal structure of the Mo—Cu alloy layer is uniform and dense, having no defects like segregation, holes, inclusions or etc. The CPC laminated composite material in present invention has excellent properties. Therefore, the Mo—Cu alloy in the present invention has good rollability.

TABLE 2

| | Classification parameters | D₀/μm | D₂₅/μm | D₅₀/μm | D₇₅/μm | D₉₀/μm | (D90 − D0)/D50 | D90 − D0 |
|---|---|---|---|---|---|---|---|---|
| raw molybdenum | | 0.26 | 3.04 | 4.81 | 7.12 | 10.53 | 2.14 | 10.27 |
| powder in Example 1 | | | | | | | | |
| dispersed molybdenum | coarse powder accounted for 10%; | 0.54 | 2.88 | 4.47 | 6.23 | 8.02 | 1.67 | 7.48 |
| powder in Example 1 | fine powder accounted for 1% | | | | | | | |
| dispersed molybdenum | coarse powder accounted for 7%; | 1.69 | 3.29 | 4.80 | 6.22 | 8.68 | 1.46 | 6.99 |
| powder in Example 2 | fine powder accounted for 7% | | | | | | | |
| dispersed molybdenum | coarse powder accounted for 7%; | 1.15 | 3.16 | 4.73 | 6.65 | 8.71 | 1.60 | 7.56 |
| powder in Example 3 | fine powder accounted for 5% | | | | | | | |

TABLE 3

| | | | | | | | Mean | | Thickness | |
|---|---|---|---|---|---|---|---|---|---|---|
| | | | | | | | Thickness | | Deviation | |
| | | | | | | | a single | multiple | a single | multiple |
| unit: μm | | 1 | 2 | 3 | 4 | 5 | layer | layers | layer | layers |
| Example 1 | Mo—Cu | 689.895 | 689.895 | 689.895 | 689.283 | 689.283 | 689.650 | | 0.09% | |
| | alloy layer | | | | | | | | | |
| | The first | 167.862 | 167.862 | 167.862 | 167.862 | 167.862 | 167.862 | 167.862 | 0.00% | 0.00% |
| | copper layer | | | | | | | | | |
| | The second | 167.862 | 167.862 | 167.862 | 167.862 | 167.862 | 167.862 | | 0.00% | |
| | copper layer | | | | | | | | | |
| Example 2 | Mo—Cu | 503 | 505 | 506 | 508 | 503 | 505 | | 0.99% | |
| | alloy layer | | | | | | | | | |
| | The first | 255 | 253 | 249 | 248 | 252 | 251.4 | 250.7 | 2.78% | 0.56% |
| | copper layer | | | | | | | | | |
| | The second | 250 | 251 | 248 | 251 | 250 | 250 | | 1.20% | |
| | copper layer | | | | | | | | | |
| Example 3 | Mo—Cu | 503 | 520 | 523 | 531 | 530 | 521.4 | | 5.37% | |
| | alloy layer | | | | | | | | | |
| | The first | 496 | 480 | 473 | 470 | 487 | 481.2 | 485.5 | 5.40% | 1.77% |
| | copper layer | | | | | | | | | |
| | The second | 497 | 496 | 490 | 483 | 483 | 489.8 | | 2.86% | |
| | copper layer | | | | | | | | | |

Finally, it should be noted that the particular Examples above are provided merely for illustrating the present invention instead of limiting it. Although preferable Examples are described in the present invention specifically illustrating the present invention, those skilled in the art should know that: the specific embodiments of the invention can still be modified and the technical features can still be equivalently replaced, yet without departing from the spirit of the present invention. All such modifications and equivalents should fall in the scope of the claimed embodiments of the present invention.

1. A method of producing a Mo—Cu alloy, comprising the following steps:
(1) providing dispersed molybdenum powder,
(2) producing a molybdenum skeleton with said dispersed molybdenum powder in step (1),
(3) infiltrating said molybdenum skeleton in step (2) with copper and said Mo—Cu alloy is obtained;
wherein, said dispersed molybdenum powder has (D90−D0)/D50 of less than or equal to 2.1.

2. The method according to claim 1, wherein said dispersed molybdenum powder has D90−D0 of less than or equal to 20 μm.

3. The method according to claim 1, wherein said dispersed molybdenum powder has D50 of 1 to about 20 μm.

4. The method according to claim 1, wherein step (1) comprises the following steps:
adjusting the particle size of the raw molybdenum powder,
said step of adjusting the particle size of the raw molybdenum powder denotes the following: crushing the agglomerates in the molybdenum powder to obtain primary particles, and then removing a coarse powder accounted for more than or equal to 1% of the total mass of the molybdenum powder and/or removing a fine powder accounted for more than or equal to 1% of the total mass of molybdenum powder by classifying.

5. The method according to claim 4, wherein said step of adjusting the particle size of the raw molybdenum powder is carried out with an air crushing and classifying device.

6. The method according to claim 4, wherein said raw molybdenum powder has D50 of 1 to about 20 μm.

7. The method according to claim 1, wherein step (2) comprises the following steps:
compacting a dispersed molybdenum powder or a powder blend including a dispersed molybdenum powder and a copper powder into a green compact;
and optionally, sintering said green compact.

8. The method according to claim 1, wherein said infiltrating in step (3) is carried out at a temperature of 1250 to about 450° C.

9. The method according to claim 1, wherein said infiltrating in step (3) proceeds for 1 to about 5 hours.

10. The method according to claim 1, wherein said infiltrating in step (3) is carried out in a copper infiltrating furnace.

11. A Mo—Cu alloy produced by the method as claimed in claim 1.

12. The Mo—Cu alloy according to claim 11, wherein the Mo—Cu alloy has a molybdenum content of at least 40% by weight.

13. The Mo—Cu alloy according to claim 11, wherein the Mo—Cu alloy has a relative density of more than or equal to 95%.

14. A Mo—Cu alloy sheet obtained by processing the Mo—Cu alloy as claimed in claim 11.

15. The Mo—Cu alloy sheet as claimed in claim 14, wherein the Mo—Cu alloy sheet has a surface roughness Ra of less than or equal to 1.4 μm.

16. The Mo—Cu alloy sheet as claimed in claim 14, wherein the Mo—Cu alloy sheet has a thickness tolerance of within ±0.3 mm.

17. The Mo—Cu alloy sheet as claimed in claim 14, wherein said processing is diamond wire cutting, or said processing is wire cutting and polishing.

18. A method of producing a CPC laminated composite material, comprising the following steps:
(1) forming a multilayer sheet by laminating a copper sheet, a Mo—Cu alloy sheet and a copper sheet together in sequence; and
(2) rolling the multilayer sheet,
Wherein said Mo—Cu alloy sheet is the Mo—Cu alloy sheet as claimed in claim 14.

19. The method according to claim 18, further comprising a step between steps (1) and (2) of mechanically fixing each layer of the multilayer sheet.

20. The method according to claim 18, wherein said rolling in step (2) includes one or more steps of cold rolling and/or hot rolling, optionally, and further includes steps of annealing.

21. A CPC laminated composite material produced by the method as claimed in claim 18.

22. A CPC laminated composite material comprising one Mo—Cu alloy layer and two copper layers, with said Mo—Cu alloy layer being sandwiched between the two copper layers, wherein the thickness deviation of said Mo—Cu alloy layer is less than or equal to 10%.

23. The CPC laminated composite material according to claim 22, wherein the thickness deviation of said copper layer is less than or equal to 10%.

24. The CPC laminated composite material according to claim 22, wherein the thickness deviation of the two copper layers is less than or equal to 10%.
